(19) United States
(12) Patent Application Publication
(10) Pub. No.: US 2018/0241848 A1
(43) Pub. Date: Aug. 23, 2018

(54) HUMAN-READABLE CLOUD STRUCTURES

(71) Applicant: HEWLETT PACKARD ENTERPRISE DEVELOPMENT LP, Houston, TX (US)

(72) Inventors: Jeffrey Joel Walls, Ft. Collins, CO (US); Bryan P. Murray, Bellevue, WA (US)

(73) Assignee: Hewlett Packard Enterprise Development LP, Houston, TX (US)

(21) Appl. No.: 15/752,022

(22) PCT Filed: Sep. 11, 2015
(86) PCT No.: PCT/US2015/049833

§ 371 Date: Feb. 12, 2018

(51) Int. Cl. H04L 29/08; H04L 12/24

(52) U.S. Cl. CPC H04L 67/36; H04L 41/145

(57) ABSTRACT

Examples relate to human-readable cloud structures. Some examples disclosed herein may enable identifying cloud definition data describing a cloud to be deployed. The cloud definition data comprises a set of structural attributes that define a structure of the cloud and a set of non-structural attributes. Some examples may enable generating a first human-readable artifact that describes the structure of the cloud in natural language using the set of structural attributes of the cloud definition data, modifying a portion of the cloud definition data, generating a second human-readable artifact describing the structure of the cloud in natural language using the set of structural attributes of the cloud definition data that includes the modified portion, and determining whether the structure of the cloud in the second human-readable artifact is different from the structure of the cloud in the first human-readable artifact by comparing the first human-readable artifact with the second human-readable artifact.

### BACKGROUND

Computing infrastructure service providers such as cloud service providers offer Internet-based computing where shared resources are provided to users as a service. Cloud computing, for example, enables provisioning of dynamically scalable and often virtualized resources on demand.

### BRIEF DESCRIPTION OF THE DRAWINGS

The following detailed description references the drawings, wherein:

FIG. 1 is a block diagram depicting an example environment in which various examples may be implemented as a cloud structure system.

FIG. 2 is a block diagram depicting an example cloud structure system.

FIG. 3 is a block diagram depicting an example machine-readable storage medium comprising instructions executable by a processor for generating human-readable cloud structures.

FIG. 4 is a block diagram depicting an example machine-readable storage medium comprising instructions executable by a processor for generating human-readable cloud structures.

FIG. 5 is a flow diagram depicting an example method for generating human-readable cloud structures.

FIG. 6 is a flow diagram depicting an example method for generating human-readable cloud structures.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Computing infrastructure service providers such as cloud service providers offer network-based computing where shared resources are provided to users as a service. Cloud computing, for example, enables provisioning of dynamically scalable and often virtualized resources on demand. A cloud may comprise a particular cloud infrastructure that describes various cloud components (e.g., networks, compute nodes, storage nodes, etc.) and their relationships in a cloud environment. As such, the cloud, when successfully deployed, may set up the various cloud components according to a specified infrastructure in the cloud environment. The shared resources may be provisioned on demand from the cloud.

Once the cloud is deployed, it may be challenging to fix any unintended configurations of cloud components or otherwise modify the configurations because it would require deploying a whole new cloud infrastructure with the modified configurations. Furthermore, changes to the cloud configurations for subsequent deployments may have unexpected changes to the structure of the cloud, resulting in an inoperable cloud and/or substantial cloud downtime.

Examples disclosed herein may provide technical solutions to such challenges by providing a way to validate the structure of the cloud before deploying one. A human-readable artifact that describes the structure of the cloud in natural language may be generated for the validation. For example, a user (e.g., cloud developer, architect, administrator, etc.) may inspect the human-readable artifact to ensure that code changes that the user has made to the cloud do not structurally change the cloud.

Some examples disclosed herein may enable identifying cloud definition data describing a cloud to be deployed. The cloud definition data comprises a set of structural attributes that define a structure of the cloud and a set of non-structural attributes. Some examples may enable generating a first human-readable artifact that describes the structure of the cloud in natural language using the set of structural attributes of the cloud definition data, modifying a portion of the cloud definition data, generating a second human-readable artifact describing the structure of the cloud in natural language using the set of structural attributes of the cloud definition data that includes the modified portion, and determining whether the structure of the cloud in the second human-readable artifact is different from the structure of the cloud in the first human-readable artifact by comparing the first human-readable artifact with the second human-readable artifact.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

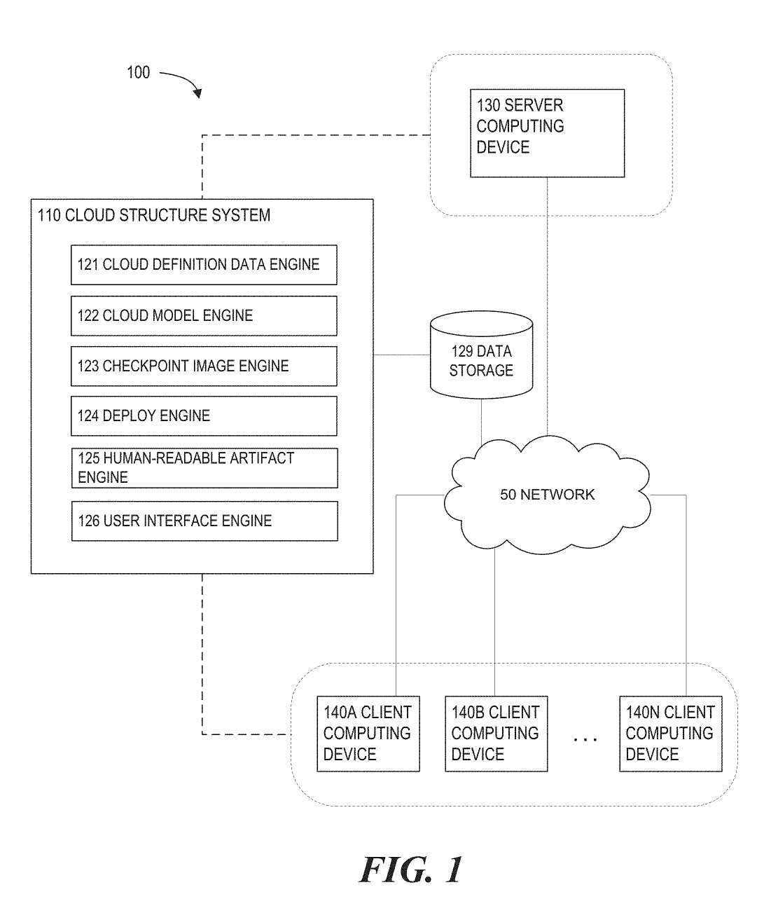

FIG. 1 is an example environment 100 in which various examples may be implemented as a cloud structure system 110. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may be any type of computing device providing a user interface through which a user can interact with a software application. For example, client computing devices 140 may include a laptop computing device, a desktop computing device, an all-in-one computing device, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving at least one software application for consumption by client computing devices 140.

The various components (e.g., components 129, 130, and/or 140) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, cloud structure system 110 and the various components described herein may be implemented in hardware and/or a combination of hardware and programming that configures hardware. Furthermore, in FIG. 1 and other Figures described herein, different numbers of components or entities than depicted may be used.

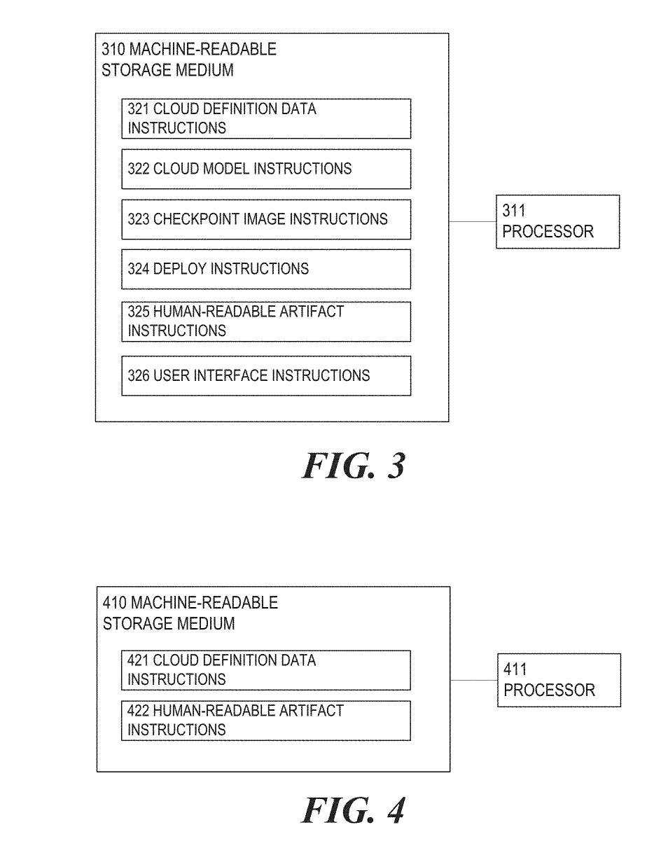

Cloud structure system 110 may comprise cloud definition data engine 121, cloud model engine 122, checkpoint image engine 123, a deploy engine 124, a human-readable artifact engine 125, a user interface engine 126, and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

Cloud definition data engine 121 may identify and/or obtain cloud definition data that describes a cloud to be deployed. For example, cloud definition data engine 121 may obtain first cloud definition data that describe a first cloud, second cloud definition data that describe a second cloud, third cloud definition data that describe a third cloud, and so on.

“Cloud definition data,” as used herein, may comprise network topology (e.g., a network architecture of physical and/or virtual networks including management network, Intelligent Platform Management Interface (IPMI) network, service network, storage network, external network, etc.), node lists (e.g., a list of physical and/or virtual servers including compute nodes, storage nodes, network nodes, etc.), operating systems, Application Program Interfaces (APIs), software applications, and/or other information that describe a particular cloud infrastructure. In some implementations, the cloud definition data may specify and/or include at least one control plane and/or at least one data plane. A control plane may comprise a set of networks, nodes, APIs, applications, etc. and may provide tasks such as provisioning, policy management, and/or monitoring to the underlying resources on a data plane.

In some implementations, the cloud definition data may comprise a set of structural attributes that define a structure of the cloud and a set of non-structural attributes. The structure of the cloud may relate to control planes in the cloud, tiers of the control planes, members of the tiers, nodes, networks, or the like. For example, the set of structural attributes comprise a name of the cloud, a number of control planes in the cloud, names of the control planes, a number of tiers for each of the control planes, names of the tiers, a number of members for each of the tiers, names of the members, a number of nodes in each of the control planes, types of the nodes (e.g., compute node, storage node, etc.), a name of a network in the cloud, or any combination thereof.

The non-structural attributes, on the other hand, do not define the structure of the cloud. This means that any changes to the non-structural attributes do not change, modify, or otherwise affect the structure of the cloud. The non-structural attributes may be subject to frequent changes from one deployment to another. Examples of the non-structural attributes may include service-level attributes (e.g., service timeout attribute that specifies how long it takes before a service gives up, service port attribute that specifies ports a service is listening on, etc.), node-level attributes (e.g., an Internet Protocol (IP) address assigned to a node of the cloud, API rate limit attribute that specifies how quickly clients can access the API, client socket timeout attribute that specifies how long it takes before a socket connection gives up, etc.), or the like.

The cloud definition data may be defined and/or obtained in various ways. For example, at least a portion of the cloud definition data may be defined or otherwise provided by a customer based on its requirements for cloud usage. In another example, at least a portion of the cloud definition data may be defined or otherwise provided by a cloud architect who designs the cloud infrastructure based on the customer requirements.

In some implementations, a user may want to change, modify, or otherwise update the cloud definition data. A change may be made to at least a portion of the structural attributes and/or the non-structural attributes. For example, a new tier may be added to and/or defined in the existing control plane, modifying the structure of the cloud. An existing node may be removed from the cloud, modifying the structure of the cloud. In another example, the service timeout configured for a particular service or services may be set longer than the existing timeout value. Note that this change to the service timeout attribute would not affect the structure of the cloud.

In some implementations, a user (e.g., a cloud architect) may want to create multiple what-if scenarios to simulate various different cloud infrastructures before deploying any one of them. The user may review, compare, and/or validate different scenarios and/or make a determination as to which scenario should be used for the actual deployment. These scenarios may be referred to herein as “cloud models” (e.g., as discussed herein with respect to cloud model engine 122).

Cloud model engine 122 may generate a cloud model based on the cloud definition data (e.g., obtained by cloud definition data engine 121) that describes a particular cloud to be deployed. The cloud model may comprise a set of configuration artifacts that, when executed, cause the cloud (e.g., that the cloud definition data describes) to be deployed. For example, the cloud definition data may be translated and/or converted into the set of configuration artifacts that can be used and are suitable for the deployment of the particular cloud. For example, the configuration artifacts may represent executable code that, when executed, builds and/or deploys the particular cloud including the networks, nodes, software applications, and/or other components described by the cloud definition data. The set of configuration artifacts may include but not be limited to a network artifact, a configuration management artifact, and/or a monitoring artifact (e.g., that may be used to build a monitoring system that monitors, logs, and/or audits the cloud infrastructure). In one example, when these configuration artifacts are executed to deploy the particular cloud, the deployed cloud may have the structure as defined by the set of structural attributes in the cloud definition data.

Note that a plurality of cloud models may be generated based on different sets of cloud definition data. For example, cloud model engine 122 may generate a first cloud model based on the first cloud definition data, a second cloud model based on the second cloud definition data, a third cloud model based on the third cloud definition data, and so on. The first cloud model may comprise a first set of configuration artifacts that, when executed, cause the first cloud to be deployed, the second cloud model may comprise a second set of configuration artifacts that, when executed, cause the second cloud to be deployed, the third cloud model may comprise a set of third configuration artifacts that, when executed, cause the third cloud to be deployed, and so on.

In some implementations, the second cloud definition data may be created by modifying or otherwise updating the first cloud definition data, as discussed herein with respect to cloud definition data engine 121. For example, the set of structural attributes may be updated where a new node is added to the cloud. In another example, the set of non-structural attributes may be updated such that a service timeout attribute for a particular service in the cloud is modified. As such, cloud model engine 122 may generate an updated cloud model based on the updated cloud definition data (e.g., the second cloud definition data).

Checkpoint image engine 123 may generate and/or store a checkpoint image of the cloud model. The “checkpoint image,” as used herein, may comprise at least a portion of the cloud definition data and/or at least a portion of the set of configuration artifacts. In other words, the checkpoint image may include all of the cloud definition data, a portion of the cloud definition data, all of the set of configuration artifacts, and/or a portion of the set of configuration artifacts. The checkpoint image may be stored in a data storage (e.g., data storage 129). In some implementations, a plurality of checkpoint images (e.g., including different portions of the cloud definition data or configuration artifacts) may be generated for the same cloud model.

In some implementations, checkpoint image engine 123 may manage changes (e.g., adding, deleting, modifying, updating, etc.) to the checkpoint image via version-control. Any changes to the checkpoint image may be tracked using version-control. For example, the checkpoint image may be checked-out by a user so that no other users can make changes to the image. The user may subsequently check-in the image to commit the changes the user made to the image. The version-control may track the identification of the user who made the changes, a timestamp associated with the changes, a duration of the check-out, a version number, and/or other modification history related to the image. In addition, the version-control may also provide a capability to rollback any changes made to the checkpoint image.

In some implementations, checkpoint image engine 123 may determine a difference between at least two checkpoint images. For example, checkpoint image engine 123 may determine a difference between a first checkpoint image (e.g., of the first cloud model generated based on the first cloud definition data that describe the first cloud) and a second checkpoint image (e.g., of the second cloud model generated based on the second cloud definition data that describe the second cloud). In doing so, checkpoint image engine 123 may compare the first checkpoint image with the second checkpoint image to identify at least one artifact in one of the first and second checkpoint images that is different from the other of the first and second checkpoint images. The difference may comprise at least one artifact that should be added to the first cloud that has been already deployed, updated in the first cloud, and/or deleted from the first cloud.

For example, assuming that at least a portion of the non-structural attributes of the first cloud definition data has been modified without modifying any of the structural attributes of the first cloud definition data, the difference between the first checkpoint image and the second checkpoint image may include configuration artifacts that are related to the modified portion of the non-structural attributes. In this example, executing this difference between the first and second checkpoint images would not change the structure of the cloud. In another example, assuming that at least a portion of the structural attributes of the first cloud definition data has been modified, the difference between the first checkpoint image and the second checkpoint image may include configuration artifacts that are related to the modified portion of the structural attributes. In this case, executing this difference would affect the structure of the cloud. To avoid unintentionally changing the structure of the cloud, an additional validation step may be ensued to validate that the structure of the cloud remains the same prior to deploying the second or updated cloud, which is discussed in detail herein with respect to human-readable artifact engine 125.

Such differencing technique may be useful, in some examples, when the first cloud has been already deployed but the second cloud is now desired in view of the customer's new requirements. In order to deploy the second cloud, the access to the first cloud can be temporarily blocked while the second cloud is being deployed and become fully operational. Such downtime may be reduced by executing the difference to deploy the second cloud without having to block the access to the first cloud.

Deploy engine 124 may execute the cloud model to cause the corresponding cloud to be deployed. The set of configuration artifacts of the cloud model may be executed to build a particular cloud infrastructure of the cloud. The particular cloud infrastructure may therefore have a cloud architecture that was intended by the cloud definition data.

Different cloud models may be executed to deploy different cloud infrastructures. As discussed above with respect to checkpoint image engine 123, the determined difference may be executed to update the infrastructure of the cloud from the first cloud to the second cloud. For example, certain artifacts may be added to the first cloud, updated in the first cloud, and/or deleted from the first cloud. Although the deployment of the first and second cloud models are discussed above, additional cloud models (or differences thereof) may be also executed. For example, deploy engine 124 may execute a difference between the first checkpoint image and a third checkpoint image (e.g., of a third cloud model generated based on third cloud definition data that describe a third cloud).

Human-readable artifact engine 125 may generate a human-readable artifact that describes the structure of the cloud in natural language using the set of structural attributes of the cloud definition data. Since the non-structural attributes of the cloud definition data do not describe the structure of the cloud, the non-structural attributes are excluded from the generation of the human-readable artifact. In this way, the structure of the cloud can be easily readable and/or validated by a user (e.g., a cloud architect or other human inspectors) without having to be bothered by unnecessary or irrelevant non-structural details of the cloud. For example, the human-readable artifact may comprise a text file that reads:

The “Knight” cloud was created with a nickname of “Vegas” and 3 defined control planes. The 1^{st} control plane is a “Cloud Control Plane” (ccp) and has 2 tiers. The 1^{st} tier in this control plane is clustered, having 2 members in the cluster. The 2^{nd} tier in this control plane is clustered, having 2 members in the cluster. There are no resource nodes defined in this control plane. The 2^{nd} control plane is a “Resource Pool Control Plane 1” (rcp01) and has 1 tier. The 1^{st} tier in this control plane is clustered, having 2 members in the cluster. There is 1 Compute Node (cpn) defined in this control plane. The 3^{rd} control plane is a “Resource Pool Control Plane 2” (rcp02) and has 1 tier. The 1^{st} tier in this control plane is clustered, having 2 members in the cluster. There is 1 Compute Node (cpn) defined in this control plane.

Moreover, the human-readable artifact may describe a server allocation aspect of the cloud. For example, the artifact may include the following structural description of the cloud:

An “HP DL680” server has been allocated to the rcp01 control plane as a “Cloud Controller” in the 2^{nd} member of the 1^{st} tier. Its hostname is “KNIGHTVEGAS-RCP01-T1-M2-NETPXE” and it is in the nova failure zone. This server has a logical interface “INTF0.” This logical interface is bound to the physical Ethernet port “eth0.”

In some implementations, human-readable artifact engine 125 may generate multiple different human-readable artifacts describing the structure of the cloud. For example, there may be a first human-readable artifact that describes the structure of the cloud using the set of structural attributes of the cloud definition data. The cloud definition data may be subsequently modified or otherwise updated (as discussed above with respect to cloud definition data engine 121). Human-readable artifact engine 125 may generate a second human-readable artifact that describes the structure of the cloud using the set of structural attributes of the updated cloud definition data.

In some implementations, human-readable artifact engine 125 may provide a human-readable artifact to be used for validation. For example, a user may inspect the human-readable artifact by reading the artifact written in natural language to determine whether the structure of the cloud is designed as intended by the user. In some implementations, human-readable artifact engine 125 may provide at least two human-readable artifacts (e.g., the first and second human-readable artifacts) to be used for validating whether the structure of the cloud is identical between the first and second human-readable artifacts. In doing so, human-readable artifact engine 125 may compare the first and second human-readable artifacts and/or identify a portion in one of the two human-readable artifacts that is different from the other of the two human-readable artifacts. For example, if the first human-readable artifact generated based on the structural attributes of the cloud definition data and the second human-readable artifact generated based on the structural attributes of the updated cloud definition data are indeed identical, this can validate that the structure of the cloud remains the same after updating the cloud definition data. This also means that the updates were not made to the structural attributes of the cloud definition data. In another example, if at least a portion of one of the two human-readable artifacts is different from the other of the two human-readable artifacts, this means that the structure of the cloud has been changed after updating the cloud definition data. In this example, the first human-readable artifact may show 3 control planes but the second human-readable artifact may show a new control plane in addition to the existing 3 control planes. The structural attributes related to the new control plane may be identified as a portion that is different from the first human-readable artifact.

In some implementations, the above validation of the cloud structure using human-readable artifacts may occur prior to executing the updated cloud model and/or executing the difference between the first and second checkpoint images. In response to validating that the structure of the cloud is identical between the first and second human-readable artifacts, the updated cloud model (and/or the difference between the first and second checkpoint images) may be executed to deploy the updated cloud (via deploy engine 124). This ensures that the changes that have been made to the cloud definition data and/or cloud model did not modify the structure of the cloud and that executing the updated cloud model would not make unintended or unexpected structural changes to the cloud.

User interface engine 126 may cause the identified portion (e.g., the new control plane in the second human-readable artifact, using the example above) to be displayed, via a user interface, visually different from the rest of that human-readable artifact. For example, the identified portion may be highlighted on the user interface such that the user may easily understand where the structural change has been made. In another example, the identified portion may be shown in a different font, color, pattern, and/or any other visually distinguishing indicator.

In some implementations, user interface engine 126 may receive a user input (e.g., via the user interface) that modifies the identified portion (e.g., the new control plane in the second human-readable artifact, using the example above). For example, a user may want to roll back any structural changes made to the cloud (e.g., the new control plane that was added to the existing cloud structure may be removed). In some instances, the cloud model may be updated based on the modification (e.g. the new control plane that was added to the existing cloud structure may be removed) where the updated cloud model would no longer structurally change the cloud. The user, after being assured that this updated cloud model would not structurally change the cloud, may initiate the execution of the updated cloud model.

In performing their respective functions, engines 121-125 may access data storage 129 and/or other suitable database(s). Data storage 129 may represent any memory accessible to cloud structure system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Cloud structure system 110 may access data storage 129 locally or remotely via network 50 or other networks.

Data storage 129 may include a database to organize and store data. The database may reside in a single or multiple physical device(s) and in a single or multiple physical location(s). The database may store a plurality of types of data and/or files and associated data or file description, administrative information, or any other data.

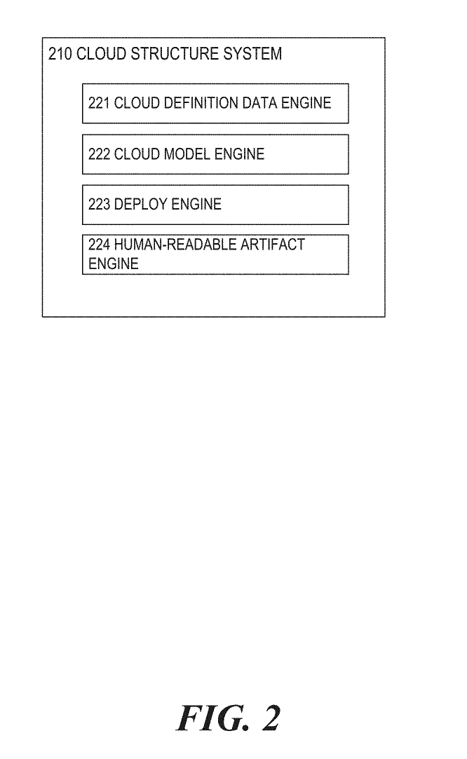

FIG. 2 is a block diagram depicting an example cloud structure system 210. Cloud structure system 210 may comprise a cloud definition data engine 221, a cloud model engine 222, a deploy engine 223, a human-readable artifact engine 224, and/or other engines. Engines 221-224 represent engines 121, 122, 124, and 125, respectively.

FIG. 3 is a block diagram depicting an example machine-readable storage medium 310 comprising instructions executable by a processor for generating human-readable cloud structures.

In the foregoing discussion, engines 121-126 were described as combinations of hardware and programming. Engines 121-126 may be implemented in a number of fashions. Referring to FIG. 3, the programming may be processor executable instructions 321-326 stored on a machine-readable storage medium 310 and the hardware may include a processor 311 for executing those instructions. Thus, machine-readable storage medium 310 can be said to store program instructions or code that when executed by processor 311 implements cloud structure system 110 of FIG. 1.

In FIG. 3, the executable program instructions in machine-readable storage medium 310 are depicted as cloud definition data instructions 321, cloud model instructions 322, checkpoint image instructions 323, deploy instructions 324, human-readable artifact instructions 325, and user interface instructions 326. Instructions 321-326 represent program instructions that, when executed, cause processor 311 to implement engines 121-126, respectively.

FIG. 4 is a block diagram depicting an example machine-readable storage medium 410 comprising instructions executable by a processor for generating human-readable cloud structures.

In the foregoing discussion, engines 121-126 were described as combinations of hardware and programming. Engines 121-126 may be implemented in a number of fashions. Referring to FIG. 4, the programming may be processor executable instructions 421-422 stored on a machine-readable storage medium 410 and the hardware may include a processor 411 for executing those instructions. Thus, machine-readable storage medium 410 can be said to store program instructions or code that when executed by processor 411 implements cloud structure system 110 of FIG. 1.

In FIG. 4, the executable program instructions in machine-readable storage medium 410 are depicted as cloud definition data instructions 421 and human-readable artifact instructions 422. Instructions 421-422 represent program instructions that, when executed, cause processor 411 to implement engines 121 and 125, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed can be executed by processor 311 (or processor 411) to implement cloud structure system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-326, and/or other instructions. As an alternative or in addition to retrieving and executing instructions, processor 311 may include at least one electronic circuit comprising a number of electronic components for performing the functionality of at least one of instructions 321-326, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-422, and/or other instructions. As an alternative or in addition to retrieving and executing instructions, processor 411 may include at least one electronic circuit comprising a number of electronic components for performing the functionality of at least one of instructions 421-422, and/or other instructions.

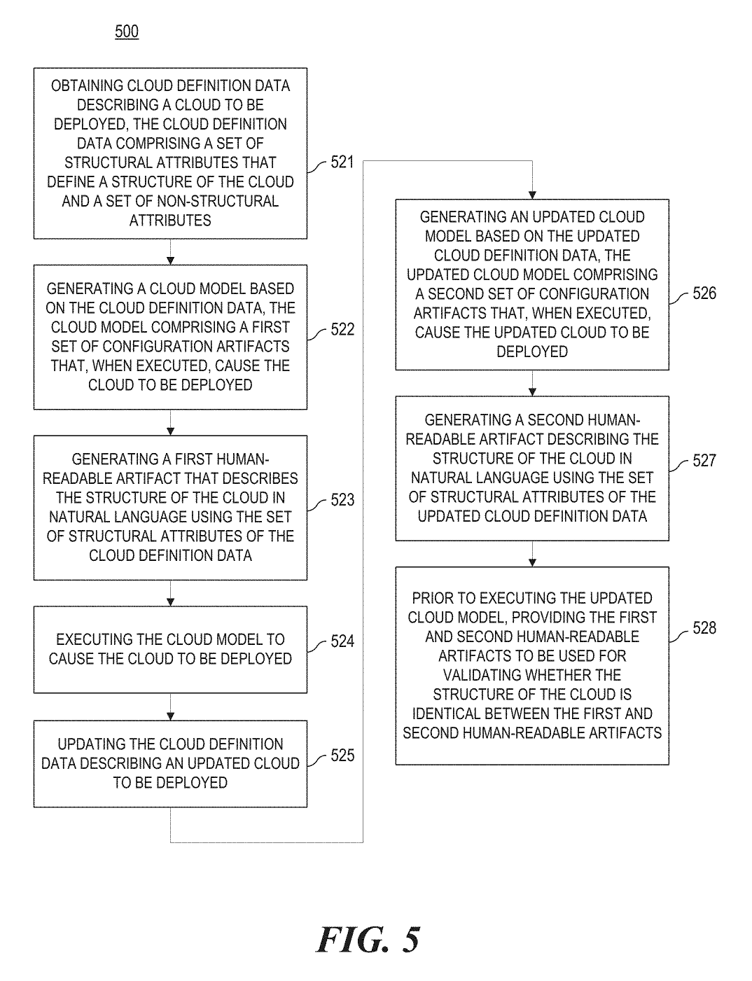

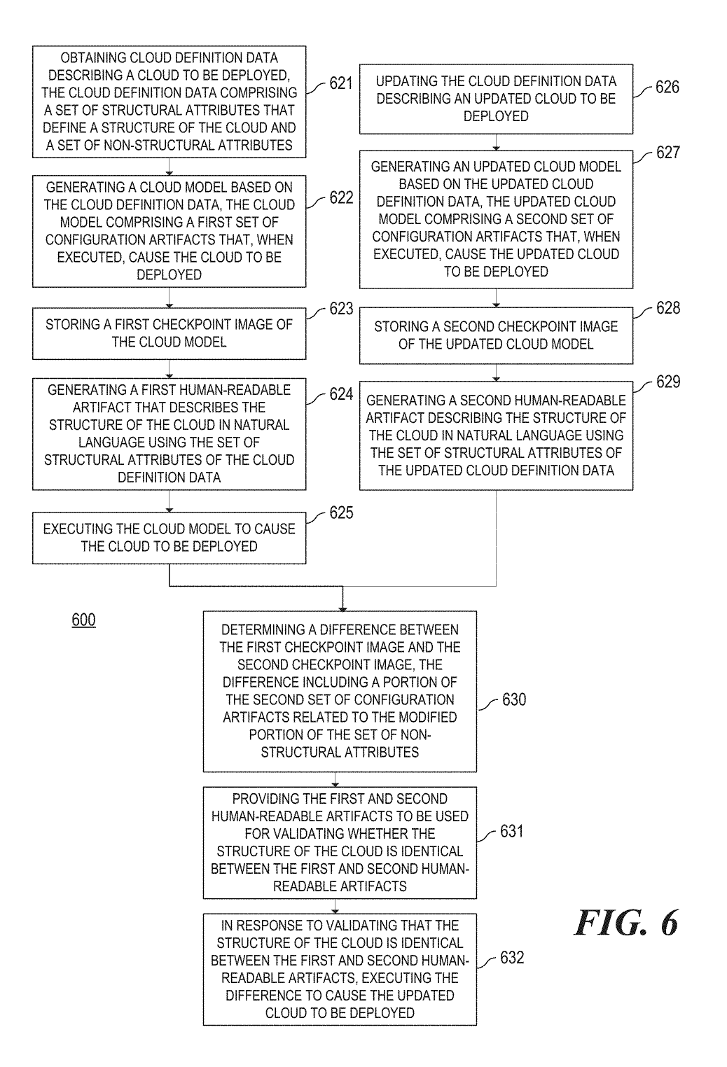

FIG. 5 is a flow diagram depicting an example method 500 for generating human-readable cloud structures. The various processing blocks and/or data flows depicted in FIG. 5 (and in the other drawing figures such as FIG. 6) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant be an example and, as such, should not be viewed as limiting. Method 500 may be implemented in the form of executable instructions stored on a machine-readable storage medium, such as storage medium 310, and/or in the form of electronic circuitry.

In block 521, method 500 may include obtaining cloud definition data describing a cloud to be deployed. The cloud definition data may comprise a set of structural attributes that define a structure of the cloud and a set of non-structural attributes. Referring back to FIG. 1, cloud definition data engine 121 may be responsible for implementing block 521.

In block 522, method 500 may include generating a cloud model based on the cloud definition data. The cloud model may comprise a first set of configuration artifacts that, when executed, cause the cloud to be deployed. Referring back to FIG. 1, cloud model engine 122 may be responsible for implementing block 522.

In block 523, method 500 may include generating a first human-readable artifact that describes the structure of the cloud in natural language using the set of structural attributes of the cloud definition data. Referring back to FIG. 1, human-readable artifact engine 125 may be responsible for implementing block 523.

In block 524, method 500 may include executing the cloud model to cause the cloud to be deployed. Referring back to FIG. 1, deploy engine 126 may be responsible for implementing block 524.

In block 525, method 500 may include updating the cloud definition data describing an updated cloud to be deployed. Referring back to FIG. 1, cloud definition data engine 121 may be responsible for implementing block 525.

In block 526, method 500 may include generating an updated cloud model based on the updated cloud definition data. The updated cloud model may comprise a second set of configuration artifacts that, when executed, cause the updated cloud to be deployed. Referring back to FIG. 1, cloud model engine 122 may be responsible for implementing block 526.

In block 527, method 500 may include generating a second human-readable artifact describing the structure of the cloud in natural language using the set of structural attributes of the updated cloud definition data. Referring back to FIG. 1, human-readable artifact engine 125 may be responsible for implementing block 527.

In block 528, method 500 may include, prior to executing the updated cloud model, providing the first and second human-readable artifacts to be used for validating whether the structure of the cloud is identical between the first and second human-readable artifacts. Referring back to FIG. 1, human-readable artifact engine 125 may be responsible for implementing block 528.

FIG. 6 is a flow diagram depicting an example method 600 for generating human-readable cloud structures. Method 600 as illustrated (and described in greater detail below) is meant be an example and, as such, should not be viewed as limiting. Method 600 may be implemented in the form of executable instructions stored on a machine-readable storage medium, such as storage medium 210, and/or in the form of electronic circuitry.

Blocks 621, 622, 624-627, 629, and 631 are discussed above in blocks 521-528 of FIG. 5, respectively.

In block 623, method 600 may include storing a first checkpoint image of the cloud model. Referring back to FIG. 1, checkpoint image engine 123 may be responsible for implementing block 623.

In block 628, method 600 may include storing a second checkpoint image of the updated cloud model. Referring back to FIG. 1, checkpoint image engine 123 may be responsible for implementing block 628.

In block 630, method 600 may include determining a difference between the first checkpoint image and the second checkpoint image. The difference may include a portion of the second set of configuration artifacts related to the modified portion of the set of non-structural attributes. Referring back to FIG. 1, checkpoint image engine 123 may be responsible for implementing block 630.

In block 632, method 600 may include, in response to validating that the structure of the cloud is identical between the first and second human-readable artifacts, executing the difference to cause the updated cloud to be deployed. Referring back to FIG. 1, deploy engine 124 may be responsible for implementing block 632.

The foregoing disclosure describes a number of example implementations for human-readable cloud structures. The disclosed examples may include systems, devices, computer-readable storage media, and methods for generating human-readable cloud structures. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for generating human-readable cloud structures, the method comprising:
obtaining cloud definition data describing a cloud to be deployed, the cloud definition data comprising a set of structural attributes that define a structure of the cloud and a set of non-structural attributes;
generating a cloud model based on the cloud definition data, the cloud model comprising a first set of configuration artifacts that, when executed, cause the cloud to be deployed;
generating a first human-readable artifact that describes the structure of the cloud in natural language using the set of structural attributes of the cloud definition data;
executing the cloud model to cause the cloud to be deployed;
updating the cloud definition data describing an updated cloud to be deployed;
generating an updated cloud model based on the updated cloud definition data, the updated cloud model comprising a second set of configuration artifacts that, when executed, cause the updated cloud to be deployed;
generating a second human-readable artifact describing the structure of the cloud in natural language using the set of structural attributes of the updated cloud definition data; and
prior to executing the updated cloud model, providing the first and second human-readable artifacts to be used for validating whether the structure of the cloud is identical between the first and second human-readable artifacts.

2. The method of claim 1, wherein the set of structural attributes comprise a name of the cloud, a number of control planes in the cloud, names of the control planes, a number of tiers for each of the control planes, a number of members for each of the tiers, a number of nodes in each of the control planes, types of the nodes, a name of a network in the cloud, or any combination thereof.

3. The method of claim 1, wherein any changes made to the set of non-structural attributes do not change the structure of the cloud.

4. The method of claim 1, wherein updating the cloud definition data comprises:
modifying a portion of the set of structural attributes.

5. The method of claim 4, wherein the structure of the cloud in the first human-readable artifact is different from the structure of the cloud in the second human-readable artifact.

6. The method of claim 1, wherein updating the cloud definition data comprises:
modifying a portion of the set of non-structural attributes, wherein the set of structural attributes remain un-modified.

7. The method of claim 6, wherein the structure of the cloud is identical between the first and second human-readable artifacts.

8. The method of claim 1, further comprising:
in response to validating that the structure of the cloud is identical between the first and second human-readable artifacts, executing the updated cloud model to cause the updated cloud to be deployed.

9. The method of claim 6, further comprising:
storing a first checkpoint image of the cloud model;
storing a second checkpoint image of the updated cloud model;
determining a difference between the first checkpoint image and the second checkpoint image, the difference including a portion of the second set of configuration artifacts related to the modified portion of the set of non-structural attributes; and
in response to validating that the structure of the cloud is identical between the first and second human-readable artifacts, executing the difference to cause the updated cloud to be deployed.

10. The method of claim 9, wherein the difference comprises at least one artifact that should be added to the cloud that has been deployed, updated in the cloud that has been deployed, or deleted from the cloud that has been deployed.

11. A non-transitory machine-readable storage medium comprising instructions executable by a processor of a computing device for generating human-readable cloud structures, the machine-readable storage medium comprising:
instructions to identify cloud definition data describing a cloud to be deployed, the cloud definition data comprising a set of structural attributes that define a structure of the cloud and a set of non-structural attributes;
instructions to generate a first human-readable artifact that describes the structure of the cloud in natural language using the set of structural attributes of the cloud definition data;
instructions to modify a portion of the cloud definition data;
instructions to generate a second human-readable artifact describing the structure of the cloud in natural language using the set of structural attributes of the cloud definition data that includes the modified portion; and
instructions to determine whether the structure of the cloud in the second human-readable artifact is different from the structure of the cloud in the first human-readable artifact by comparing the first human-readable artifact with the second human-readable artifact.

12. The non-transitory machine-readable storage medium of claim 11, further comprising:
instructions to identify a portion of the second human-readable artifact that is different from the first human-readable artifact; and
instructions to cause the identified portion to be displayed, via a user interface, visually different from the rest of the second human-readable artifact.

13. The non-transitory machine-readable storage medium of claim 11, further comprising:
instructions to generate a cloud model based on the cloud definition data, the cloud model comprising a first set of configuration artifacts that, when executed, cause the cloud to be deployed;
instructions to execute the cloud model to cause the cloud to be deployed;
instructions to generate an updated cloud model based on the cloud definition data including the modified portion, the updated cloud model comprising a second set of configuration artifacts that, when executed, cause an updated cloud to be deployed; and
prior to executing the updated cloud model, instructions to determine whether the structure of the cloud in the second human-readable artifact is different from the structure of the cloud in the first human-readable artifact by comparing the first human-readable artifact with the second human-readable artifact.

14. The non-transitory machine-readable storage medium of claim 11, wherein modifying the portion of the cloud definition data comprises modifying a portion of the set of structural attributes, further comprising:
instructions to determine that the structure of the cloud in the second human-readable artifact is different from the structure of the cloud in the first human-readable artifact.

15. The non-transitory machine-readable storage medium of claim 11, wherein the set of structural attributes define control planes in the cloud, tiers of the control planes, members of the tiers, networks in the cloud, or any combination thereof.

16. A system for generating human-readable cloud structures, the system comprising:
a processor that:
obtains cloud definition data describing a cloud to be deployed, the cloud definition data comprising a set of structural attributes that define a structure of the cloud and a set of non-structural attributes;
generates a cloud model based on the cloud definition data, the cloud model comprising a set of configuration artifacts that, when executed, cause the cloud to be deployed;
generates a first human-readable artifact that describes the structure of the cloud in natural language using the set of structural attributes of the cloud definition data;
executes the cloud model to cause the cloud to be deployed;
updates the cloud definition data;
generates an updated cloud model based on the updated cloud definition data;
generates a second human-readable artifact that describes the structure of the cloud in natural language using the set of structural attributes of the updated cloud definition data; and
prior to executing the updated cloud model, identifies a portion in one of the first and second human-readable artifacts that is different from the other of the first and second human-readable artifacts.

17. The system of claim 16, the processor that:
causes the identified portion to be displayed, via a user interface, visually different from the rest of the first or second human-readable artifact.

18. The system of claim 17, the processor that:
causes the identified portion to be highlighted on the user interface.

19. The system of claim 16, the processor that:
receives a user input that modifies the identified portion, wherein the cloud model is updated based on the modification.

20. The system of claim 16, wherein the set of configuration artifacts comprise a network artifact, a configuration management artifact, a monitoring artifact, and any combination thereof.
